(19) United States
(12) Patent Application Publication
(10) Pub. No.: US 2012/0303992 A1
(43) Pub. Date: Nov. 29, 2012

(54) DISPLAY AND POWER MANAGEMENT METHOD THEREOF

(75) Inventors: Qing Xu, Beijing (CN); Pengfei Zhang, Shenzhen (CN); Hao Shen, Shenzhen (CN)

(73) Assignees: BEIJING LENOVO SOFTWARE LTD., Beijing (CN); LENOVO (BEIJING) LIMITED, Beijing (CN)

(21) Appl. No.: 13/574,131

(22) PCT Filed: Jan. 21, 2011
(86) PCT No.: PCT/CN11/00106

§ 371 Date: Jul. 19, 2012

(30) Foreign Application Priority Data
Jan. 22, 2010 (CN) 201010100573.3

(51) Int. Cl. G06F 1/32

(52) U.S. Cl. 713/324

(57) ABSTRACT

A display and a power management method thereof are disclosed. The method includes: detecting a state of a Graphic Interface Card (GIC) in the display; turning off power supply to the GIC when the GIC is in a first state; and turning on power supply to the GIC when the GIC is in a second state. The method is capable of reducing power consumption of a display to satisfy environment protection requirements without sacrificing the functionality of the display's GIC.

### TECHNICAL FIELD

The present invention relates to display, and more particularly, to a display having an integrated Graphic Interface Card (GIC) and a power management method thereof.

### BACKGROUND

With widespread use of Universal Serial Bus (USB) technique, GICs having USB interface will be widely used. The following problems occur when integrating a USB GIC into a display.

FIG. 1 is a diagram showing connection between a display having an integrated USB GIC and a Personal Computer (PC). As shown in FIG. 1, the PC is connected via a USB cable with the USB GIC which is integrated in the display. A signal outputted from the PC is inputted to the USB GIC via the USB cable and outputted on the screen of the display via the USB GIC.

According to Energy Star as well as green and environment protection requirements in various regions throughout the world, there is a low power consumption requirement when a display is in a power save mode. However, in a display having an integrated USB GIC, a user may first connect the USB GIC integrated within the display to a host PC, and the USB GIC then outputs an image to the display. If the display output of the USB GIC is turned off at this time, the display will enter the power save mode. However, with improvement on resolution and performance of the GIC, the power consumption of the USB GIC and the system circuit of the display itself will be higher than the low power consumption requirement, and thus fail to satisfy the green and environment protection requirements such as Energy Star.

In the conventional display with integrated GIC, the display typically supplies power to the GIC, regardless of whether the display is in the power save mode or not. Such display cannot satisfy the low power consumption requirements in the power save mode. Also, such display power management method increases the overall power consumption of the display and cannot satisfy the environment protection requirements.

### SUMMARY

Embodiments of the present invention provide a display and a power management method thereof, capable of reducing power consumption of the display to satisfy environment protection requirements without sacrificing the functionality of the display's GIC.

According to an embodiment of the present invention, a power management method for a display is provided including: detecting a state of a Graphic Interface Card (GIC) in the display; turning off power supply to the GIC when the GIC is in a first state; and turning on power supply to the GIC when the GIC is in a second state.

According to an embodiment of the present invention, the step of turning off power supply to the GIC when the GIC is in the first state includes: turning off power supply to the GIC when the GIC is disconnected from a computer.

According to an embodiment of the present invention, the step of turning on the power supply to the GIC when the GIC is in the second state includes: turning on the power supply to the GIC when the GIC is connected to a computer.

According to an embodiment of the present invention, the step of turning on power supply to the GIC when the GIC is in the second state includes: turning on power supply to the GIC when the GIC is connected to a computer and an image signal is outputted from the GIC to the display.

According to an embodiment of the present invention, the GIC is a USB GIC. The USB GIC is determined to be connected to the computer when a power supply pin of the USB GIC is detected to have a high level.

According to another embodiment of the present invention, a display is provided including: a Graphic Interface Card (GIC); a detection module adapted to detect a state of the GIC; a first control module adapted to turn off power supply to the GIC when the GIC is in a first state; and a second control module adapted to turn on power supply to the GIC when the GIC is in a second state.

According to an embodiment of the present invention, the detection module is adapted to generate a first instruction to turn off power supply to the GIC upon detecting that the GIC is disconnected from a computer; and the first control module is adapted to turn off power supply to the GIC in response to the first instruction.

According to an embodiment of the present invention, the detection module is adapted to generate a second instruction to turn on power supply to the GIC upon detecting that the GIC is connected to a computer; and the second control module is adapted to turn on power supply to the GIC in response to the second instruction.

According to an embodiment of the present invention, the detection module is adapted to generate a third instruction to turn on power supply to the GIC upon detecting that the GIC is connected to a computer and an image signal is outputted from the GIC to the display; and the second control module is adapted to turn on power supply to the GIC in response to the third instruction.

According to an embodiment of the present invention, the GIC is a USB GIC; and the detection module is adapted to determine that the USB GIC is connected to the computer upon detecting that a power supply pin of the USB GIC has a high level.

According to the embodiments of the present invention, the state of the GIC in the display may be detected. Power supply to the GIC may turned off when it is in the first state. In this way, the display does not constantly supply power to the GIC, such that the overall power consumption of the display can be reduced. In addition, Power supply to the GIC is turned on when it is in the second state, thereby ensuring the GIC functionality of the display.

### BRIEF DESCRIPTION OF THE DRAWINGS

FIG. 1 is a diagram showing connection between a PC, a USB GIC and a display in the prior art;

FIG. 2 is a flowchart illustrating a power management method for a display according to an embodiment of the present invention;

FIG. 3 is a flowchart illustrating an implementation of the method shown in FIG. 2; and

FIG. 4 is a diagram showing structure of a display according to an embodiment of the present invention.

### DETAILED DESCRIPTION OF THE PREFERRED EMBODIMENTS

In the following, the particular embodiments will be further detailed with reference to the figures, such that the above objects, features and advantages of the present application can become more apparent.

Embodiments of the present invention may solve the problem in the prior art that the display constantly supplies power to the GIC such that the low power consumption and environment protection requirements cannot be satisfied, by providing a display and a power management method thereof, capable of reducing power consumption of the display without sacrificing functionality of the display's GIC.

As shown in FIG. 2, a power management method for a display according to an embodiment of the present invention includes the following steps.

At step 21, a state of a GIC in the display is detected.

At step 22, a power supply to the GIC is turned off when the GIC is in a first state.

At step 23, the power supply to the GIC is turned on when the GIC is in a second state.

According to the embodiment of the present invention, the GIC is integrated in the display. With the above method, the state of the GIC integrated in the display is detected. The power supply to the GIC is turned off when it is in the first state. In this way, the display does not need to constantly supply power to the GIC, such that the overall power consumption of the display can be reduced. In addition, the power supply to the GIC is turned on when it is in the second state, thereby ensuring the GIC functionality of the display.

Here, in the above method, the step 22 may include a step 221 in which the power supply to the GIC is turned off when the GIC is disconnected from a computer.

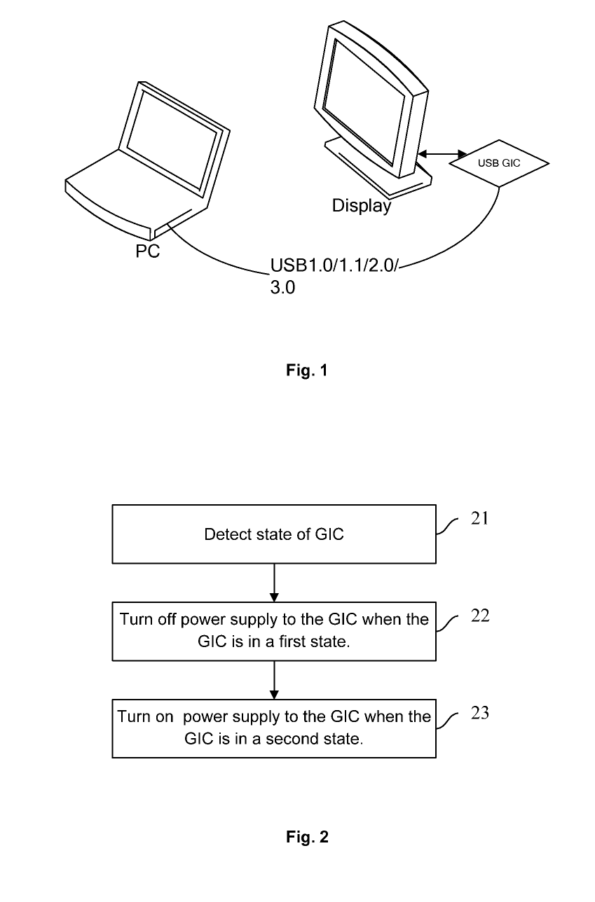

With reference to FIG. 1 as discussed above, when the GIC is disconnected from the PC, the display turned off the power supply to the GIC regardless of whether the display is in the power save state, such that the power consumption of the display can be reduced.

Here, the GIC being disconnected from the computer includes the following situations: 1) the GIC is physically disconnected from the computer, e.g., a cable connection between the GIC and the computer is removed; 2) the computer does not output any signal to the GIC when the computer is in a power save mode, such that the GIC is considered to be disconnected from the computer; 3) connection between the computer and the GIC is manually terminated by using an associated control program in the computer; and 4) the computer starts a screen saver program which turns off connection between the computer and the GIC.

Here, in the above method, the step 23 may include a step 231 in which power supply to the GIC is turned on when the GIC is connected to a computer.

With reference to FIG. 1 as discussed above, when the GIC is connected with the PC, the display needs to supply power to the GIC. In this case, even if the display is in the power save state, the GIC may be supplied with and may be waked up instantly. Thus, the functionality of the GIC will not be inactive due to lack of power supply.

In addition, in the above method, the step 23 may include a step 232 in which power supply to the GIC is turned on when the GIC is connected to a computer and an image signal is outputted from the GIC to the display.

With reference to FIG. 1 as discussed above, when it is detected that the GIC is connected with the PC and an image signal is inputted to the display via the GIC, the display is in an operating mode and needs to supply power to the GIC to ensure its functionality. In the case where the GIC is connected with the PC while no image signal is inputted to the display via the GIC (i.e., the display is in the power save mode), the display still supplies power to the GIC. In this way, the GIC may be waked up instantly and its functionality will not remain inactive.

In the above embodiments of the present invention, the GIC may be a USB GIC. The state of connection between such USB GIC and the computer may be detected in such a manner that the USB GIC is determined to be connected to the computer when a power supply pin of the USB GIC is detected to have a high level.

Typically, a USB interface has four pins, two of which are power supply pins and the other two are data pins. When the power supply pins of the USB interface are detected to be at high level, it is indicated that the GIC is connected to a computer via a USB cable.

On the other hand, if the power supply pins of the USB GIC are detected to be at low level, it is determined that the USB GIC is disconnected from the computer.

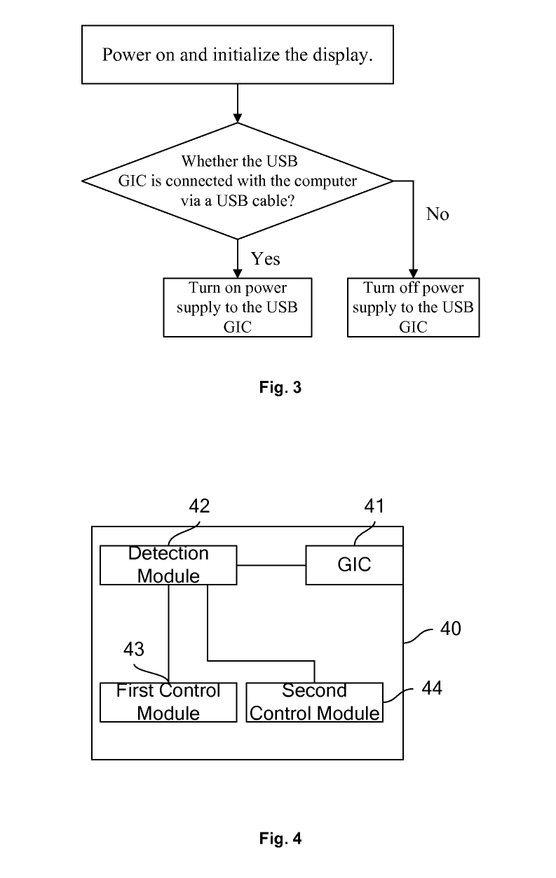

FIG. 3 shows a particular implementation of the method shown in FIG. 2, which includes the following steps.

The display is powered on and initialized. Then it is detected whether the USB GIC is connected with the computer via the USB cable. If the USB GIC is connected with the computer, the display supplies power to the USB GIC; otherwise the display does not supply power to the USB GIC.

According to the above embodiments of the present invention, a function of detecting whether a GIC is connected is incorporated in the display system. Upon detecting that the GIC is connected with a host PC, the display supplies power to the GIC regardless of whether the GIC is working. When detecting that the GIC is disconnected from the host PC and no signal is inputted to the display, the display enters the power save mode and turns off the power supply to the GIC. In this way, in a display having an integrated GIC, the power consumption problem of the GIC is solved. The above power management scheme of the present invention allows for low power consumption while ensuring the functionality of the USB GIC.

According to an embodiment of the present invention, a display 40 is provided, as shown in FIG. 4. The display 40 may include a GIC 41, such as an integrated GIC. The display 40 may further include a detection module 42 adapted to detect a state of the GIC 41; a first control module 43 adapted to turn off a power supply to the GIC 41 when the GIC 41 is in a first state; and a second control module 44 adapted to turn on the power supply to the GIC 41 when the GIC 41 is in a second state.

Here, the detection module 42 is adapted to generate a first instruction to turn off the power supply to the GIC 41 upon detecting that the GIC is disconnected from a computer. The first control module 43 is adapted to turn off the power supply to the GIC 41 in response to the first instruction.

Here, the detection module 42 is adapted to generate a second instruction to turn on the power supply to the GIC 41 upon detecting that the GIC is connected to a computer. The second control module 44 is adapted to turn on the power supply to the GIC 41 in response to the second instruction.

In addition, the detection module 42 is adapted to generate a third instruction to turn on the power supply to the GIC upon detecting that the GIC is connected to a computer and an image signal is outputted from the GIC to the display. The second control module 44 is adapted to turn on the power supply to the GIC in response to the third instruction.

According to an embodiment of the present invention, the GIC may be a USB GIC. In this case, the detection module 42 may detect a level of a power supply pin of the USB GIC and determine that the USB GIC is connected to the computer upon detecting that the power supply pin of the USB GIC has a high level.

On the other hand, the detection module 42 may determine that the USB GIC is disconnected from the computer upon detecting that the power supply pin of the USB GIC has a low level.

The GIC is not limited to the GIC having a USB interface. Rather, it can be a GIC having a PCI interface or any other standard interface capable of connecting and communicating with a display and a computer.

According to the above embodiments, in a display having an integrated USB GIC, when no image signal is outputted from the USB GIC to the display, the display normally enters a power save mode. If the USB GIC is not connected with the computer or the computer is also in a power save mode at this time, the display will be controlled to turn off the power supply to the USB GIC. That is, when entering the power save mode, the display turns off the power supply to the USB GIC.

In the display according to the above embodiments of the present invention, a function of detecting whether a GIC is connected is incorporated in the display system. Upon detecting that the GIC is connected with a host PC, the display supplies power to the GIC regardless of whether the GIC is working. When detecting that the GIC is disconnected from the host PC and no signal is inputted to the display, the display enters the power save mode and turns off the power supply to the GIC. According to the embodiments of the present invention, in a display having an integrated GIC, it is possible to solve the power that the consumption problem of the GIC cannot satisfy the low power consumption requirements while ensuring the functionality of the USB GIC.

The preferred embodiments of the present invention have been described above. It should be noted that a number of variations and modifications can be made by those skilled in the art without departing from the principle of the present invention. These variations and modifications should be encompassed by the scope of the present invention.

What is claimed is:

1. A power management method for a display, comprising:
detecting a state of a Graphic Interface Card (GIC) in the display;
turning off power supply to the GIC when the GIC is in a first state; and
turning on power supply to the GIC when the GIC is in a second state.

2. The power management method of claim 1, wherein the step of turning off the power supply to the GIC when the GIC is in the first state comprises:
turning off the power supply to the GIC when the GIC is disconnected from a computer.

3. The power management method of claim 1, wherein the step of turning on power supply to the GIC when the GIC is in the second state comprises:
turning on power supply to the GIC when the GIC is connected to a computer.

4. The power management method of claim 1, wherein the step of turning on power supply to the GIC when the GIC is in the second state comprises:
turning on power supply to the GIC when the GIC is connected to a computer and an image signal is outputted from the GIC to the display.

5. The power management method of claim 3, wherein the GIC is a USB GIC; and
the USB GIC is determined to be connected to the computer when a power supply pin of the USB GIC is detected to have a high level.

6. A display, comprising:
a Graphic Interface Card (GIC);
a detection module adapted to detect a state of the GIC;
a first control module adapted to turn off power supply to the GIC when the GIC is in a first state; and
a second control module adapted to turn on power supply to the GIC when the GIC is in a second state.

7. The display of claim 6, wherein the detection module is adapted to generate a first instruction to turn off power supply to the GIC upon detecting that the GIC is disconnected from a computer; and
the first control module is adapted to turn off power supply to the GIC in response to the first instruction.

8. The display of claim 6, wherein the detection module is adapted to generate a second instruction to turn on power supply to the GIC upon detecting that the GIC is connected to a computer; and
the second control module is adapted to turn on power supply to the GIC in response to the second instruction.

9. The display of claim 6, wherein the detection module is adapted to generate a third instruction to turn on power supply to the GIC upon detecting that the GIC is connected to a computer and an image signal is outputted from the GIC to the display; and
the second control module is adapted to turn on power supply to the GIC in response to the third instruction.

10. The display of claim 8, wherein the GIC is a USB GIC; and
the detection module is adapted to determine that the USB GIC is connected to the computer upon detecting that a power supply pin of the USB GIC has a high level.
